(19) United States
(12) Patent Application Publication
(10) Pub. No.: US 2014/0061161 A1
(43) Pub. Date: Mar. 6, 2014

(54) CONDUCTION BREAKING DEVICE

(71) Applicant: TOYODA GOSEI CO., LTD., Kiyosu-shi (JP)

(72) Inventors: Yoshiki NAKAMURA, Kiyosu-shi (JP); Takaki FUKUYAMA, Kiyosu-shi (JP); Yoshiaki KAMEDA, Kiyosu-shi (JP)

(73) Assignee: TOYODA GOSEI CO., LTD., Kiyosu-shi (JP)

(21) Appl. No.: 13/950,395

(22) Filed: Jul. 25, 2013

(30) Foreign Application Priority Data
Aug. 31, 2012 (JP) 2012-191633

(51) Int. Cl. H01H 33/06; H01H 33/74; H01H 33/18

(52) U.S. Cl. CPC H01H 33/06; H01H 33/182; H01H 33/74
USPC 218/26; 218/46; 218/117

(57) ABSTRACT

A conduction breaking device includes a conductive body arranged between a pair of devices in an electric circuit, a gas generator, which is arranged away from the conductive body and generates gas, and a cutting member, which is arranged between the conductive body and the gas generator. The cutting member is moved due to gas from the gas generator to cut the conductive body, divides the conductive body into a first cut piece and a second cut piece, which have cut ends separated from each other, and breaks the conduction between the devices. The conduction breaking device includes an arc-extinguishing chamber. In the arc-extinguishing chamber, the conductive body is cut by the cutting member and an arc occurring between the cut end of the first cut piece and the cut end of the second cut piece is extinguished.

### BACKGROUND OF THE INVENTION

The present invention relates to a conduction breaking device for breaking conduction between a pair of devices in an electric circuit by cutting a conductive body extending between the devices.

Electric circuits are provided with a conduction breaking device for breaking conduction between devices by being operated when malfunction occurs in a device in the electric circuit or a system on which the electric circuit is mounted. As one form thereof, a conduction breaking device has been proposed that forcibly cuts a conductive body located between devices by moving a blade (cutting member) with gas (see Japanese Laid-Open Patent Publication No. 11-232979, for example).

The conduction breaking device of the above type includes a case for housing part of the conductive body. A gas generator for generating gas is arranged away from the conductive body inside the case. An accommodating chamber is formed between the conductive body and the gas generator in the case, and the cutting member is movably arranged in the accommodating chamber.

With the conduction breaking device, when gas is generated from the gas generator, the cutting member is moved by the gas, and cuts the conductive body and divides it into one pair of cut pieces with respective cut ends separated from each other. Thereby, the conductive body is divided between the cut ends, and thus conduction between the devices is broken.

### SUMMARY OF THE INVENTION

When the conduction breaking device is operated to break the conductive body in a current-carrying state, an arc may occur due to the potential difference caused between the cut ends of the pair of cut pieces. The arc refers to a phenomenon in which insulation due to gas present between the cut ends is broken and current flows.

The shorter the distance between the cut ends, the more easily an arc occurs. On the other hand, copper or aluminum typically used for the conductive body has high ductility. Thus, when the cutting member is to be rapidly moved by gas to cut the conductive body, the conductive body is largely extended, and consequently the distance between the cut ends is shorter and the arc easily occurs. When an arc occurs, the cut ends result in a state of being electrically connected. In this case, the conductive body may remain in a current-carrying state (conduction may not be broken) irrespective of being physically cut. Additionally, the arc may melt the conductive body and its surrounding plastic members.

The conventional conduction breaking device described in Japanese Laid-Open Patent Publication No. 11-232979 is configured such that the cutting member is moved by gas to cut the conductive body, but solutions for the arc are not particularly considered.

Accordingly, it is an object of the present invention to provide a conduction breaking device capable of extinguishing an arc caused between cut ends at cutting of conductive body and reducing influence due to the arc.

To achieve the foregoing objective, and in accordance with one aspect of the present invention, a conduction breaking device is provided. The conduction breaking device includes a conductive body, a gas generator, and a cutting member. The conductive body is arranged between a pair of devices in an electric circuit. The gas generator is arranged away from the conductive body and generates gas. The cutting member is arranged between the conductive body and the gas generator. The cutting member is moved by gas from the gas generator to cut the conductive body, divides the conductive body into a first cut piece and a second cut piece, which have cut ends separated from each other, and breaks the conduction between the devices. The conduction breaking device includes an arc-extinguishing chamber. The conductive body is cut by the cutting member in the arc-extinguishing chamber. An arc occurring between the cut end of the first cut piece and the cut end of the second cut piece is extinguished in the arc-extinguishing chamber.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating the internal structure of a conduction breaking device according to a first embodiment of the present invention;

FIG. 2 is a diagram illustrating a schematic structure of an electric circuit to which the conduction breaking device of FIG. 1 is applied;

FIG. 3 is an enlarged partial cross-sectional view illustrating section X of FIG. 1;

FIG. 4 is a partial cross-sectional view illustrating a state in which the conductive body of FIG. 3 is cut;

FIG. 5 is a diagram illustrating a conduction breaking device according to a second embodiment of the present invention, and is a partial cross-section view illustrating a state before the conductive body is cut;

FIG. 6 is a partial cross-sectional view illustrating a state in which the conductive body of FIG. 5 is cut;

FIG. 7 is a diagram illustrating a conduction breaking device according to a third embodiment of the present invention, and is a partial cross-sectional view illustrating a state in which the conductive body is cut;

FIG. 8 is a diagram illustrating a conduction breaking device according to a fourth embodiment of the present invention, and is a partial cross-section view illustrating a state before the conductive body is cut;

FIG. 9 is a perspective view illustrating a cutting member used in the conduction breaking device according to the fourth embodiment;

FIG. 10 is a partial cross-sectional view illustrating a state in which the conductive body of FIG. 8 is cut; and

FIG. 11 is a partial cross-sectional view illustrating a modification of the conduction breaking device of the first embodiment.

### DETAILED DESCRIPTION OF THE PREFERRED EMBODIMENTS

### First Embodiment

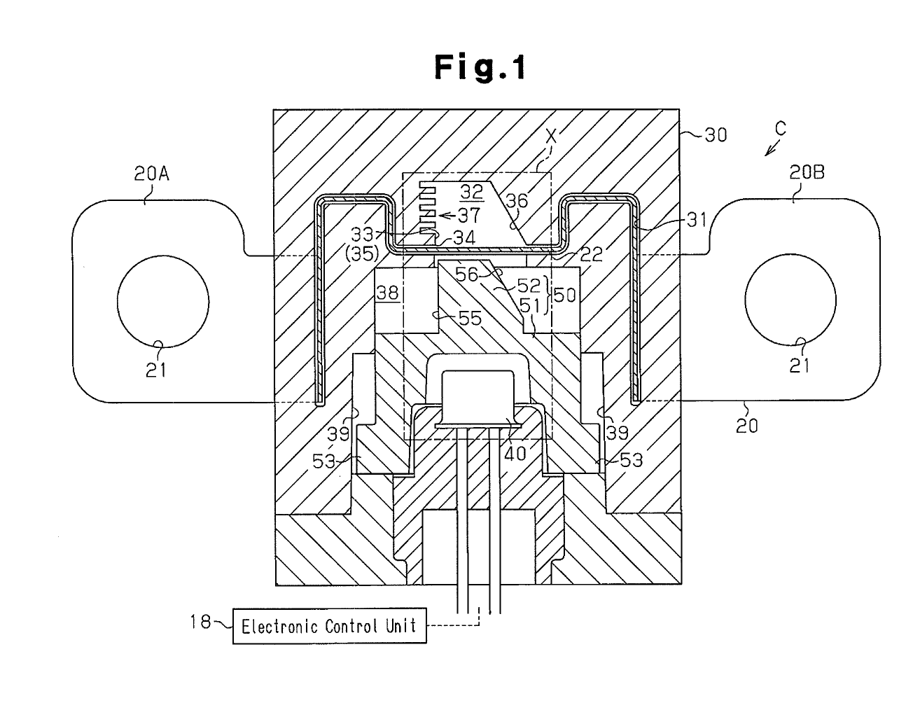

A conduction breaking device C according to a first embodiment of the present invention will be described below with reference to FIGS. 1 to 4.

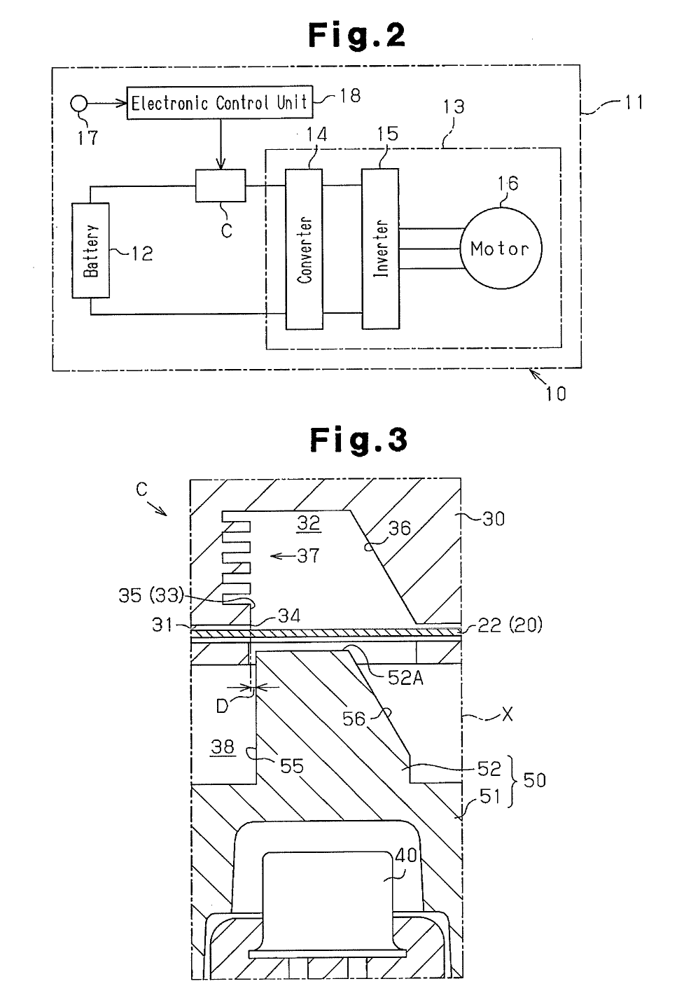

FIG. 2 illustrates an electric circuit 11 to which the conduction breaking device C according to the first embodiment is applied. The electric circuit 11 includes a pair of devices, which are a storage battery 12 and an electric device 13. In the electric circuit 11, the electric device 13 is operated by DC electricity supplied from the storage battery 12. The electric device 13 is configured by a converter 14, which increases the voltage of electricity input from the storage battery 12 and outputs the increased voltage, an inverter 15, which converts DC electricity input from the converter 14 into AC electricity suitable for driving a motor and outputs the AC electricity, and a motor 16, which is driven by the AC electricity output from the inverter 15.

The electric circuit 11 is mounted on a vehicle 10. When the vehicle 10 is damaged by a collision, for example, the electric device 13 may not properly operate or current leakage from the electric circuit 11 may be caused. Thus, the vehicle 10 is provided with the conduction breaking device C for breaking conduction between a pair of devices in the electric circuit 11, such as between the storage battery 12 (specifically, its positive electrode) and the electric device 13, on the collision. The vehicle 10 includes a collision sensor 17 for detecting presence of a collision and outputting the detected result as an output signal, and an electronic control unit 18, which is configured mainly of a microcomputer and into which the output signal of the collision sensor 17 is input. Then, when detecting a collision of the vehicle 10 based on the output signal of the collision sensor 17, the electronic control unit 18 activates the conduction breaking device C. Accordingly, electricity supplied from the storage battery 12 to the electric device 13 is broken.

As illustrated in FIG. 1, the conduction breaking device C includes a conductive body 20, a case 30, an explosive type gas generator 40 and a cutting member 50. Components in the conduction breaking device C will be described below.

### <Conductive Body 20>

The conductive body 20 forms a conduction path for electrically connecting the storage battery 12 and the converter 14. The conductive body 20 is formed in a rectangular plate shape and is made of a metal material having a high electric conductivity. For such metal material, copper is desirable, but other material such as brass or aluminum may be used. The conductive body 20 has a pair of external connectors 20A and 20B formed at both ends thereof. The external connectors 20A and 20B are connected to the storage battery 12 and the converter 14. The external connectors 20A, 20B are each formed with a through hole 21. A fastener such as a screw is inserted in each through hole 21 so that one of the external connectors 20A and 20B is connected to a terminal conductive with the storage battery 12 and the other is connected to a terminal conductive with the converter 14. In this way, the conductive body 20 is connected to the terminals of the storage battery 12 and the converter 14 in the electric circuit 11, respectively, with the external connectors 20A and 20B, so that the storage battery 12 and the converter 14 are electrically connected to each other via the conductive body 20.

The conductive body 20 has a breakable portion 22 between the external connectors 20A and 20B. The breakable portion 22 extends between the external connectors 20A and 20B in their arrangement direction (in the horizontal direction of FIG. 1). The direction in which the breakable portion 22 extends, or the direction in which the external connectors 20A and 20B are arranged, is denoted as a longitudinal direction of the breakable portion 22.

### <Case 30>

The case 30 is made of a material having an electrical insulating property and a high strength (such as plastic material). The case 30 includes a receiving portion 31 for receiving the conductive body 20 therein. The conductive body 20 is arranged in the receiving portion 31 with the external connectors 20A and 20B exposed to the outside of the case 30. The case 30 includes an arc-extinguishing chamber 32 at one side of the thickness direction of the breakable portion 22 (the vertical direction of FIG. 1), and an accommodating chamber 38 at the other side.

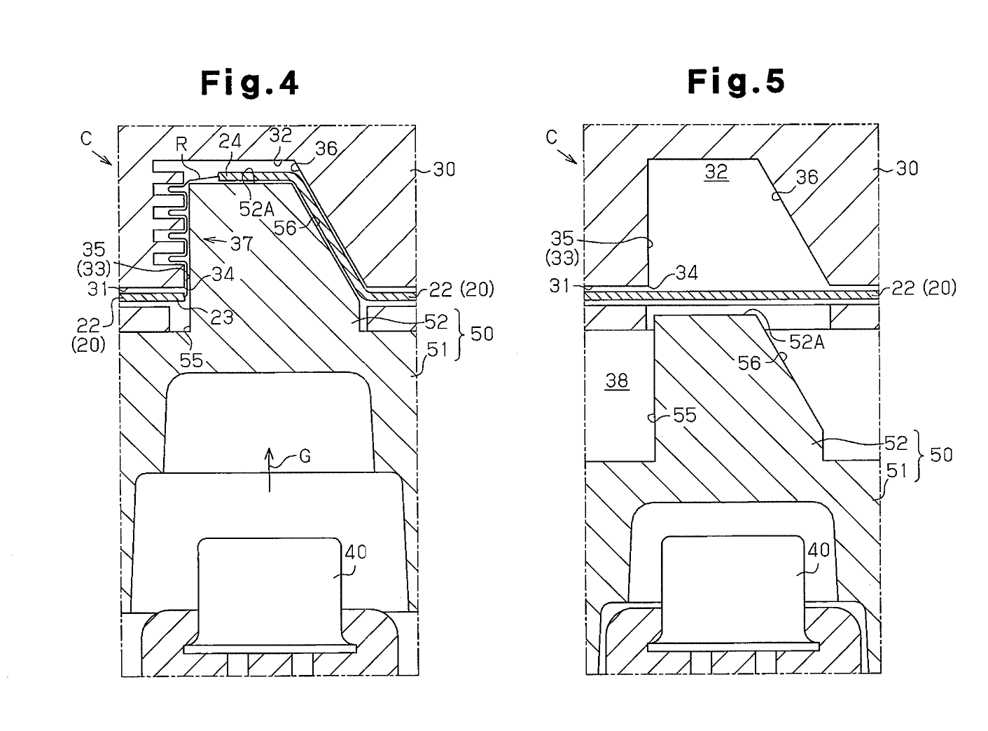

In the arc-extinguishing chamber 32, the breakable portion 22 is cut by the cutting member 50 to be divided into a first cut piece and a second cut piece with respective cut ends separated from each other. An arc caused between a cut end 24 of the first cut piece and a cut end 23 of the second cut piece (see FIG. 4) is extinguished in the arc-extinguish chamber 32. The depth of the arc-extinguishing chamber 32 (the dimension in a direction perpendicular to the sheet of the drawing) is set to be slightly larger than the width of the breakable portion 22, and the breakable portion 22 after being cut can enter the arc-extinguishing chamber 32.

As illustrated in FIG. 3, the arc-extinguishing chamber 32 is defined by a plurality of inner walls, and has a quadrangular (substantially square-shaped) opening 33 opened to the breakable portion 22 before being cut. In the opening 33, one side of the breakable portion 22 in the longitudinal direction (on the left side of FIG. 3) configures a cutting edge portion 34.

Of the mutually opposed two inner walls in the longitudinal direction of the breakable portion 22, an inner wall including the cutting edge portion 34 (on the left side of FIG. 3) is denoted as a first inner wall 35, and an inner wall not including the cutting edge portion 34 (on the right side of FIG. 3) is denoted as a second inner wall 36. The first inner wall 35 is orthogonal to the breakable portion 22 (extends in the thickness direction of the breakable portion 22). The second inner wall 36 is tilted relative to the first inner wall 35 such that as it is farther from the opening 33 (toward the upper side of FIG. 3), the distance from the first inner wall 35 decreases.

As illustrated in FIG. 4, the first inner wall 35 in the arc-extinguishing chamber 32 is formed with an uneven portion 37, which includes recesses and protrusions arranged at constant intervals in the direction extending from the cut end 24 of the first cut piece to the cut end 23 of the second cut piece (in the vertical direction of FIG. 4). Thus, the uneven portion 37 is formed on the inner wall of the arc-extinguishing chamber 32 in an area (the first inner wall 35) that at least contains an area between a position that the cut end 24 of the first cut piece approaches and a position that to the cut end 23 of the second cut piece approaches at the cutting of the breakable portion 22.

As illustrated in FIG. 1, the accommodating chamber 38 has a substantially cylindrical shape and extends in the thickness direction of the breakable portion 22. The inner wall of the accommodating chamber 38 is formed with a plurality of guide grooves 39 extending in the thickness direction.

### <Gas Generator 40>

The gas generator 40 is used as a drive source of the conduction breaking device C. The gas generator 40 is arranged in the case 30 with a part thereof exposed to the accommodating chamber 38. The gas generator 40 is connected to the electronic control unit 18. The gas generator 40 receives an operation signal from the electronic control unit 18 when gas G (see FIG. 4) is generated. The gas generator 40 ignites and burns the incorporated gunpowder in response to the input operation signal from the electronic control unit 18, thereby generating gas G.

A device driven by use of the explosive type gas generator 40 can be more quickly driven, and is of lower costs and more reliable in its operation than a device using another system (such as electromagnetic one) as a drive source.

### <Cutting Member 50>

The cutting member 50 includes a substantially cylindrical main body 51, and a blade 52, which protrudes from the main body 51 toward the arc-extinguishing chamber 32 and cuts the breakable portions 22 in cooperation with the cutting edge portion 34. The cutting member 50 is arranged between the breakable portion 22 and the gas generator 40 inside the accommodating chamber 38. Guide protrusions 53 extending in the thickness direction of the breakable portion 22 are provided at a plurality of portions on the outer surface of the main body 51. The main body 51 is engaged with the guide grooves 39 of the accommodating chamber 38 at the guide protrusions 53 to be movable in the thickness direction of the breakable portion 22.

As illustrated in FIG. 3, the blade 52 has a plurality of outer walls. Of the mutually opposed two outer walls in the longitudinal direction of the breakable portion 22 (in the horizontal direction of FIG. 3), an outer wall close to the cutting edge portion 34 (on the left side of FIG. 3) is denoted as a first outer wall 55, and the other outer wall far from the cutting edge portion 34 (on the right side of FIG. 3) is denoted as a second outer wall 56.

The first outer wall 55 of the blade 52 is orthogonal to the breakable portion 22 (extends in the thickness direction of the breakable portion 22). The first outer wall 55 is far away from the cutting edge portion 34 by a slight distance D (such as about 0.5 mm) suitable to cut (shear) the breakable portion 22 in cooperation with the cutting edge portion 34.

The second outer wall 56 of the blade 52 is tilted in association with the second inner wall 36 of the arc-extinguishing chamber 32, or is tilted toward the first outer wall 55 such that as it is farther from the main body 51 (toward the upper side of FIG. 3), the distance from the first outer wall 55 decreases.

The cutting member 50 is made of a material having an electrical insulating property and a high strength (such as plastic material), similarly to the case 30.

The conduction breaking device C according to the first embodiment is configured as described above. Operation of the conduction breaking device C will be described below.

When a collision of the vehicle 10 is not detected by the collision sensor 17, no operation signal is output from the electronic control unit 18 to the gas generator 40 in FIG. 1, and gas G is not generated from the gas generator 40. The breakable portion 22 is not cut, and the storage battery 12 and the converter 14 are kept conductive via the conductive body 20.

In contrast, when a collision of the vehicle 10 is detected by the collision sensor 17 while the conductive body 20 is conductive, an operation signal is output from the electronic control unit 18 to the gas generator 40. The gas generator 40 operates to generate gas G in response to the operation signal. The cutting member 50 is subjected to a pressure of the gas G moving toward the breakable portion 22. At this time, the guide protrusions 53 move in the guide grooves 39 of the accommodating chamber 38 so that the cutting member 50 is guided in the thickness direction of the breakable portion 22. The cutting member 50 quickly moves in an area close to the cutting edge portion 34 in the longitudinal direction of the breakable portion 22.

Along with the movement, the blade 52 contacts the breakable portion 22, and the breakable portion 22 is pressed toward the arc-extinguishing chamber 32. With the pressing, stress concentrates on the vicinity of the cutting edge 34 in the breakable portion 22. As illustrated in FIG. 4, the breakable portion 22 is cut at a part close to the cutting edge portion 34. With the cutting, the breakable portion 22 is divided into a first cut piece and a second cut piece with respective cut ends 24 and 23 separated from each other. The cut end 23 of the second cut piece is arranged near the cutting edge portion 34, and the cut end 24 of the first cut piece is arranged near a tip surface 52A of the blade 52 (an inner wall of the arc-extinguishing chamber 32 on the upper side of FIG. 4).

The conductive body 20, which is made of copper, has high ductility. When the breakable portion 22 is extended at cutting, the distance between the cut ends 23 and 24 becomes shorter, and an arc is likely to occur.

In this regard, according to the first embodiment, the conductive body 20 is cut by the cutting edge portion 34 and the blade 52 (the first outer wall 55) moving with a slight distance D away from the cutting edge portion 34. Thus, the breakable portion 22 is less extended than when the breakable portion 22 is cut only by the pressing of the cutting member 50 without the cutting edge portion 34. Thus, the interval between the cut ends 23 and 24 is larger.

The breakable portion 22 is cut between the cut ends 23 and 24, and conduction between the storage battery 12 and the converter 14 is broken. At this time, an arc may occur due to a potential difference occurring between the cut ends 23 and 24 by the cutting. That is, insulation due to gas present between the cut ends 23 and 24 may be broken, possibly leading to a current flow. At this time, the arc tends to move along the inner wall of the arc-extinguishing chamber 32 made of an electrical insulating material from the cut end 23 of the second cut piece toward the cut end 24 of the first cut piece or from the cut end 24 of the first cut piece toward the cut end 23 of the second cut piece.

According to the first embodiment, the uneven portion 37 is formed on the first inner wall 35 of the arc-extinguishing chamber 32 between a position that the cut end 24 of the first cut piece approaches and a position that the cut end 23 of the second cut piece approaches when the breakable portion 22 is cut. Thus, the arc moves along the walls of the uneven portion 37. The reference mark R in FIG. 4 indicates an arc moving path. The arc moves along the walls of the uneven portion 37. Thus, the length of the arc moving path (creeping distance) is longer than the length when the arc moves along the inner wall without the uneven portion 37.

Assuming that the second inner wall 36 is orthogonal to the breakable portion 22 before the cutting, two mutually-opposed sides in the longitudinal direction of the breakable portion 22 configure the two cutting edge portions 34, the second outer wall 56 of the cutting member 50 is orthogonal to the breakable portion 22 before the cutting, and the blade 52 moves in an area close to the cutting edge portions 34, the breakable portion 22 is cut at two portions. In this case, the cutting member 50 needs to be moved toward the arc-extinguishing chamber 32 with double load of the load when the blade 52 cuts the breakable portion 22 at one portion, and thus a larger load is needed.

In this respect, according to the present embodiment, as illustrated in FIG. 4, the second inner wall 36 is tilted toward the first inner wall 35 such that as it is farther from the opening 33 (toward the upper side of FIG. 4), the distance from the first inner wall 35 decreases. The second outer wall 56 is tilted toward the first outer wall 55 such that as it is farther from the main body 51 (toward the upper side of FIG. 4), the distance from the first outer wall 55 decreases.

Thus, when the cutting member 50 is pressed toward the arc-extinguishing chamber 32 due to gas G from the gas generator 40, the breakable portion 22 is cut between the cutting edge 34 and the first outer wall 55 of the blade 52. Additionally, the breakable portion 22 is bent at an obtuse angle along the tilted second outer wall 56 of the blade 52 and is bent at an obtuse angle along the tilted second inner wall 36 of the arc-extinguishing chamber 32, due to the pressing of the cutting member 50. A load required for the bending is smaller than a load required for the cutting. Thus, the cutting member 50 can be moved toward the arc-extinguishing chamber 32 with a small load.

The following advantages are obtained according to the first embodiment described above.

(1) The arc-extinguishing chamber 32 is formed inside the case 30. In the arc-extinguishing chamber 32, the conductive body 20 (the breakable portion 22) is cut by the blade 52 and divided into the first cut piece and the second cut piece with respective cut ends separated from each other. In addition, an arc occurring between the cut end 24 of the first cut piece and the cut end 23 of the second cut piece is extinguished (FIG. 1, FIG. 3).

Thus, even when an arc occurs between the cut ends 23 and 24 due to the cutting of the breakable portion 22, the arc can be extinguished in the arc-extinguishing chamber 32, and an impact of the arc on the conduction breaking device C is reduced as compared with the device without a measure against an arc.

Therefore, a phenomenon in which the cut ends 23 and 24 are electrically connected due to an arc and the conductive body 20 remains in a current-carrying state (conduction is not broken) does not easily occur. Further, it is possible to prevent the conductive body 20 and its surrounding plastic-made members from softening or melting due to exposure to a high temperature of arc.

(2) The arc-extinguishing chamber 32 is defined by the inner walls made of an electrical insulating material. On an inner wall of the arc-extinguishing chamber 32, the uneven portion 37 is formed in an area (the first inner wall 35) that at least contains an area between a position that the cut end 24 of the first cut piece approaches and a position that the cut end 23 of the second cut piece approaches when the cutting of the conductive body 20 (the breakable portion 22) is cut (FIG. 4).

Thus, the arc is moved along the uneven portion 37, so that the arc moving distance (creeping distance) is made longer to extinguish the arc, thereby obtaining the advantage (1).

(3) The blade 52 is moved in an area close to the cutting edge portion 34 in the longitudinal direction of the breakable portion 22, whereby the breakable portion 22 is cut between the blade 52 and the cutting edge portion 34 (FIG. 4).

Thus, the extension due to the cutting of the conductive body 20 (the breakable portion 22) is made less, and the interval between the cut ends 23 and 24 is shorter, thereby easily extinguishing the arc.

### Second Embodiment

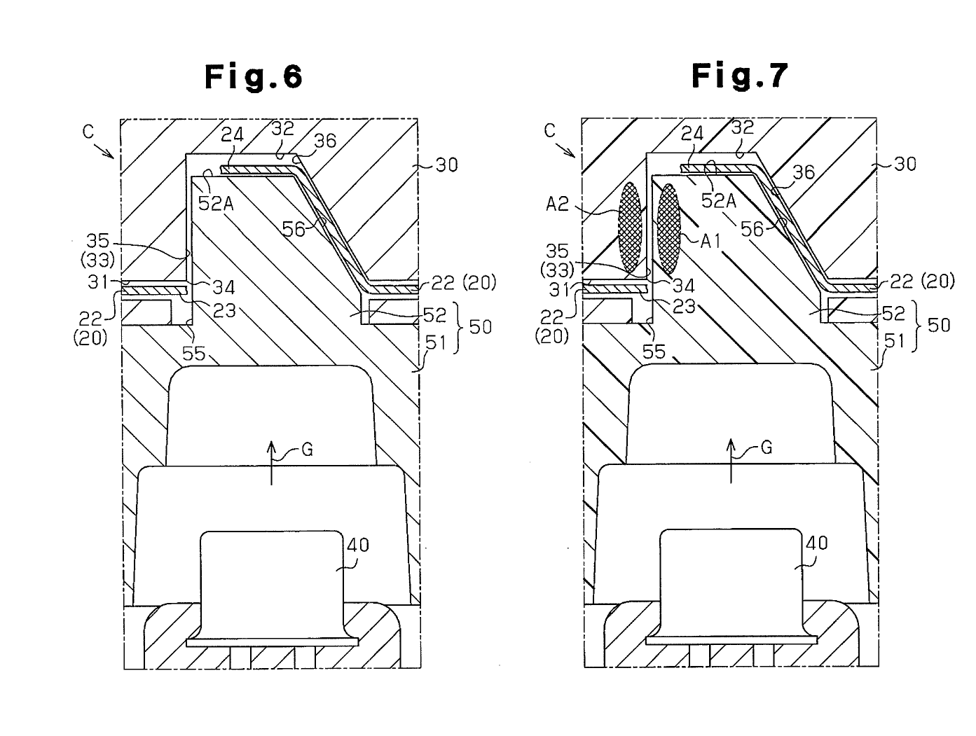

A conduction breaking device C according to a second embodiment of the present invention will be described below with reference to FIG. 5 and FIG. 6.

The second embodiment is different from the first embodiment in the structure for extinguishing an arc occurring between the cut ends 23 and 24 inside the arc-extinguishing chamber 32.

According to the second embodiment, the entire inner walls of the arc-extinguishing chamber 32 and the entire cutting member 50 are made of a material having a thermal conductivity of 0.5 W/(m·K) or more. Thus, for the inner walls of the arc-extinguishing chamber 32 and the cutting member 50, the area that at least contains a position that the cut end 24 of the first cut piece approaches and a position that the cut end 23 of the second cut piece approaches at the cutting of the conductive body 20 is made of the above material. A general-purpose plastic material mixed with a filler may be used for the above material. The uneven portion 37 according to the first embodiment is omitted from the second embodiment.

Like or the same reference numerals are given to those components that are like or the same as the corresponding components described above in the first embodiment and detailed explanations are omitted.

In the second embodiment, which has the above structure, when the breakable portion 22 in the conducting state is cut by the blade 52, the first inner wall 35 of the arc-extinguishing chamber 32 and the first outer wall 55 of the blade 52 are arranged near the area between the cut ends 23 and 24. Thus, when an arc accompanied by heat occurs between the cut ends 23 and 24 due to the cutting, the heat is discharged via the arc-extinguishing chamber 32 and the cutting member 50. At this time, the larger thermal conductivities of the arc-extinguishing chamber 32 and the cutting member 50, the greater the amount of the discharged heat becomes.

According to the second embodiment, the inner walls of the arc-extinguishing chamber 32 and the cutting member 50 are made of a material having a thermal conductivity of 0.5 W/(m·K) or more. The thermal conductivity is larger than the thermal conductivity of the general-purpose plastic material (about 0.2 W/(m·K)). Thus, more heat is discharged from the arc-extinguishing chamber 32 and the cutting member 50 than when they are made of the general-purpose plastic material. Such discharging of heat lowers the temperature of the arc.

Thus, according to the second embodiment, the following advantage is obtained, in addition to the similar advantages to the advantages (1) and (3).

(4) The inner walls of the arc-extinguishing chamber 32 and the cutting member 50 are made of a material having a high thermal conductivity of 0.5 W/(m·K) or more (FIG. 5).

Thus, even when an arc occurs between the cut ends 23 and 24 due to the cutting of the conductive body 20 (the breakable portion 22), heat of the arc is discharged through the inner walls of the arc-extinguishing chamber 32 and the cutting member 50 to lower the temperature of the arc, thereby extinguishing the arc.

### Third Embodiment

A conduction breaking device C according to a third embodiment of the present invention will be described below with reference to FIG. 7.

The third embodiment is different from the first and second embodiments in the structure for extinguishing an arc between the cut ends 23 and 24 in the arc-extinguishing chamber 32.

According to the third embodiment, the entire inner walls of the arc-extinguishing chamber 32 and the entire cutting member 50 are made of a plastic material that generates ablation gas due to an arc occurring between the cut ends 23 and 24. Thus, for the cutting member 50 (the blade 52), an area A1 between a position that the cut end 23 of the second cut piece approaches and a position that the cut end 24 of the first cut piece approaches at the cutting of the breakable portion 22 is made of the above plastic material. For the arc-extinguishing chamber 32, an area A2 between a position that the cut end 23 of the second cut piece approaches and a position that the cut end 24 of the first cut piece approaches at the cutting of the breakable portion 22 is also made of the above plastic material.

The ablation is a phenomenon in which a surface of a plastic material is decomposed due to evaporation or erosion. The ablation gas is generated by the ablation, and acts to cool an arc by latent heat of vaporization generated when a plastic material is vaporized in the ablation gas generation process.

A plastic material causing ablation gas is preferably a polymer material containing one or more carbon-carbon bonds. As the corresponding plastic material, thermosetting plastic such as unsaturated polyester or melamine plastic, or thermoplastic plastic such as polyolefin, polyamide or polyacetal can be employed.

The formation using the uneven portion 37 according to the first embodiment and materials having high thermal conductivities according to the second embodiment is omitted from the third embodiment.

According to the third embodiment having the above structure, when the conductive body 20 (the breakable portion 22) in the current-carrying state is cut by the cutting member 50 (the blade 52), an arc having heat of 5000 K or more may occur between the cut ends 23 and 24. In this case, the area A1 of the cutting member 50 and the area A2 of the arc-extinguishing chamber 32 are exposed to the heat of the arc and are thermally decomposed to generate ablation gas. The arc is cooled by latent heat of vaporization generated when the plastic material is vaporized in the ablation gas generation process.

The inner pressure of the arc-extinguishing chamber 32 is increased due to the thermally-expanded ablation gas, and thus the arc is blown off. Thus, the arc is promoted to be extinguished in this respect.

Thus, according to the third embodiment, the following advantage is obtained, in addition to the similar advantages to the advantages (1) and (3).

(5) The cutting member 50 and the inner walls of the arc-extinguishing chamber 32 are made of a plastic material that generates ablation gas due to an arc (FIG. 7).

Thus, even when an arc occurs between the cut ends 23 and 24 due to the cutting of the conductive body 20 (the breakable portion 22), the temperature of the arc is lowered by the ablation gas, thereby to extinguish the arc.

### Fourth Embodiment

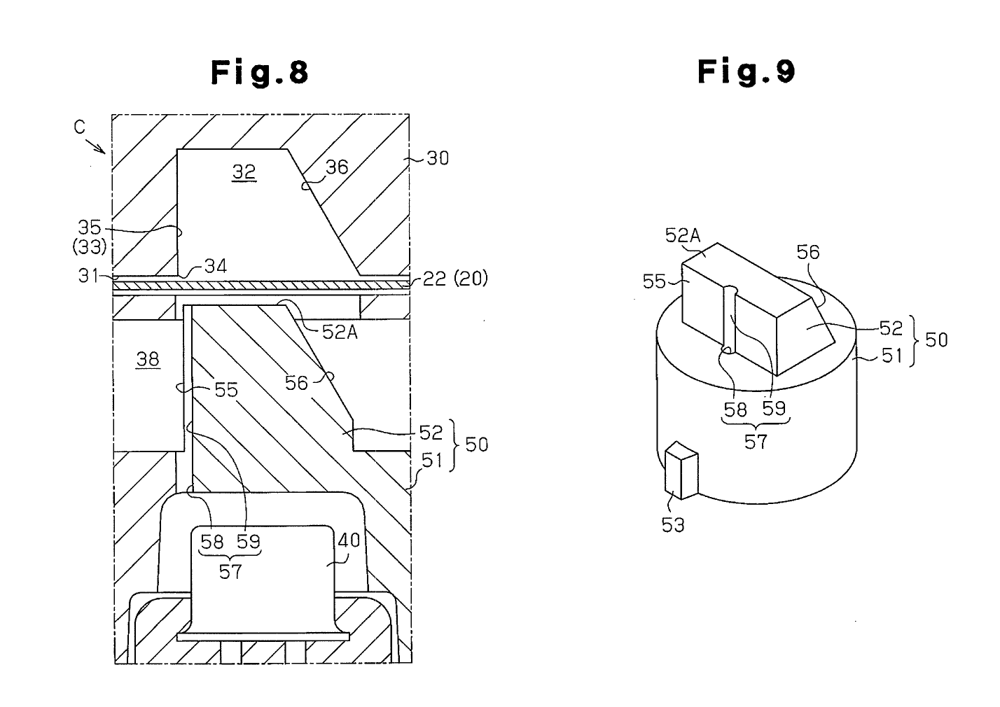

A conduction breaking device C according to a fourth embodiment of the present invention will be described below with reference to FIGS. 8 to 10.

The fourth embodiment is different from the first to third embodiments in the structure for extinguishing an arc generated between the cut ends 23 and 24 in the arc-extinguishing chamber 32.

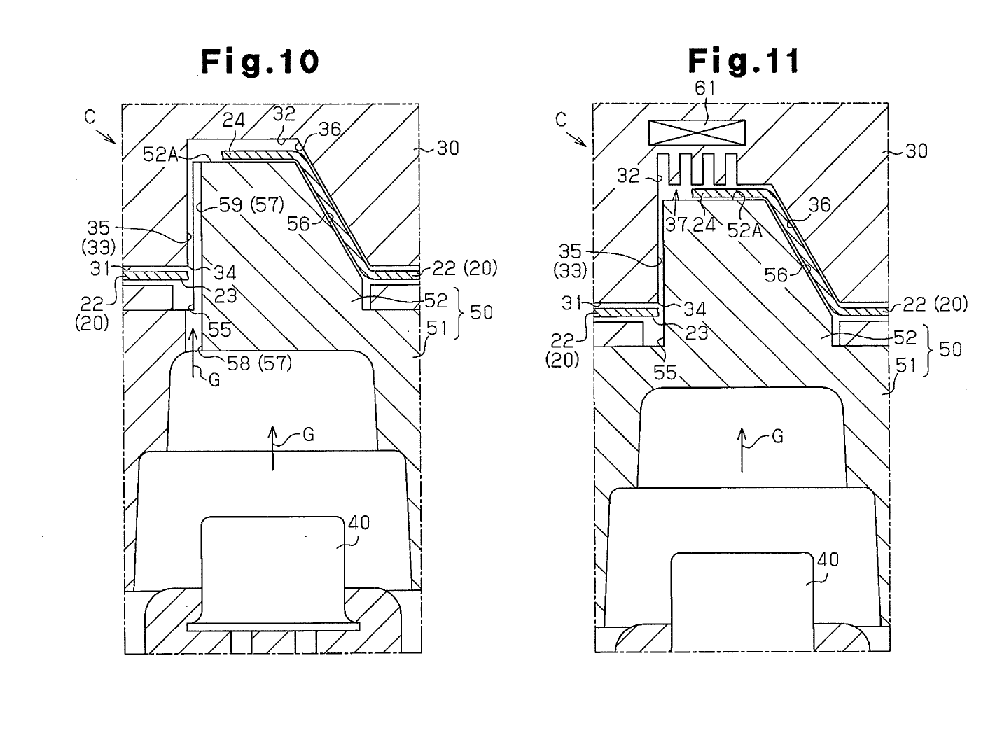

According to the fourth embodiment, a communication passage 57 is formed on the cutting member 50. The communication passage 57 linearly extends in the thickness direction of the breakable portion 22. Part of the communication passage 57 is configured of a hole 58 through the main body 51 of the cutting member 50 and having a circular cross section. One end of the hole 58 is opened to the end surface close to the gas generator 40 of the main body 51 (the lower side of FIG. 8). The remaining part of the communication passage 57 is configured of a groove 59 provided on the first outer wall 55 of the blade 52 of the cutting member 50. The groove 59 has a semicircular cross section, and is formed along the full length of the blade 52 in the thickness direction of the breakable portion 22. One end of the groove 59 extends up to the tip surface 52A of the blade 52. On the cutting of the breakable portion 22, the cut end 24 of the first cut piece approaches the one end of the groove 59 arranged at the tip surface 52A of the blade 52 in the arc-extinguishing chamber 32 (see FIG. 10).

The formation using the uneven portion 37 according to the first embodiment, materials having high thermal conductivities according to the second embodiment, and a plastic material causing ablation gas according to the third embodiment are omitted from the fourth embodiment.

According to the fourth embodiment having the above structure, the breakable portion 22 is not cut before gas G is generated from the gas generator 40 as illustrated in FIG. 8. An end of the communication passage 57 formed on the cutting member 50, which is close to the arc-extinguishing chamber 32, is closed by the breakable portion 22.

When gas G is generated by the gas generator 40 to move the cutting member 50, and the breakable portion 22 in the current-passing state is cut by the blade 52 as illustrated in FIG. 10, the end of the communication passage 57 close to the arc-extinguishing chamber 32 is opened at the same time with the cutting. The arc-extinguishing chamber 32 and the accommodating chamber 38 are communicated with each other via the communication passage 57 of the cutting member 50. Thus, part of the high-pressure gas G from the gas generator 40 flows through the communication passage 57, and is quickly blown between the cut ends 23 and 24. Thus, even when an arc occurs between the cut ends 23 and 24 due to the cutting, the arc is blown off by the gas G ejected from the communication passage 57.

In the arc discharge process, gaseous molecules are dissociated and ionized between the cut ends 23 and 24, and thus plasma is generated and a current flows thereon. Thus, the ionized gas is blown off by the gas G from the communication passage 57 and the arc is effectively extinguished.

Therefore, according to the fourth embodiment, the following advantage is obtained, in addition to the similar advantages to the advantages (1) and (3).

(6) The cutting member 50 is formed with the communication passage 57. When the breakable portion 22 is cut by the cutting member 50 (the blade 52), the communication passage 57 connects the arc-extinguishing chamber 32 and the accommodating chamber 38 with each other and blows gas G from the gas generator 40 to between the cut ends 23 and 24 (FIG. 10).

Thus, an arc occurring between the cut ends 23 and 24 is blown off and extinguished by gas G ejected from the communication passage 57 at the same time with the cutting of the breakable portion 22.

Each of the above embodiments according to the present invention may be modified as follows.

### <Modification of Arc-Extinguishing Chamber 32>

The opening 33 of the arc-extinguishing chamber 32 may be polygonal other than quadrangular. Two or more sides of the opening 33 may configure two or more cutting edge portions.

The uneven portion 37 according to the first embodiment may be formed at different portions on an inner wall of the arc-extinguishing chamber 32 from those of the first embodiment, as long as they are formed in the area that at least contains an area between a position that the cut end 24 of the first cut piece approaches and a position that the cut end 23 of the second cut piece approaches at the cutting of the conductive body 20.

The uneven portion 37 may be formed on an inner wall of the arc-extinguishing chamber 32 at portions (the inner wall on the upper side of FIG. 11) out of the area between the position that the cut end 24 of the first cut piece approaches and the position that the cut end 23 of the second cut piece approaches at the cutting of the conductive body 20 (the breakable portion 22), as illustrated in FIG. 11, instead of the first embodiment. In this case, it is desirable to arrange a magnet 61 for applying a magnetic attractive force (Lorentz force: force to be applied to charge particles moving in a magnetic field) toward the uneven portion 37 on an arc outside the arc-extinguishing chamber 32, and near the uneven portion 37 or on the opposite side of the cut end 24 of the first cut piece across the uneven portion 37.

With the above structure, when the conductive body 20 in the current-carrying state is cut by the blade 52 and an arc occurs between the cut ends 23 and 24, a magnetic attractive force of the magnet 61 acts on the arc. The arc is pulled toward the uneven portion 37 due to the magnetic attractive force. Therefore, the uneven portion 37 is formed at the portion meeting the above condition on an inner wall of the arc-extinguishing chamber 32, and however, the arc moves along the wall of the uneven portion 37. The arc moves along the uneven portion 37, and therefore, the distance (creeping distance) of the arc moving path is longer than when the uneven portion 37 is not provided, and the arc is easily extinguished. Thus, the similar advantages to those of the first embodiment are obtained also in the modification.

According to the first embodiment, similarly as in the above modification, the magnetic 61 may be arranged outside the arc-extinguishing chamber 32 and near the uneven portion 37, or on the opposite side (on the left side of FIG. 4, for example) of the cut end 24 of the first cut piece across the uneven portion 37. In this case, a magnetic attractive force toward the uneven portion 37 is applied on the arc, whereby the arc moving distance (creeping distance) is made longer than the first embodiment, and the arc-extinguishing capability by the uneven portion 37 is enhanced.

According to the second embodiment, either the inner walls of the arc-extinguishing chamber 32 or the cutting member 50 may be made of a material having a high thermal conductivity of 0.5 W/(m·K) or more. Also in this case, the area needs to be present at least between a position that the cut end 24 of the first cut piece approaches and a position that the cut end 23 of the second cut piece approaches at the cutting of the conductive body 20 (the breakable portion 22).

According to the third embodiment, either the inner walls of the arc-extinguishing chamber 32 or the cutting member 50 may be made of a plastic material that generates ablation gas due to an arc. Also in this case, the area needs to be present at least between a position that the cut end 24 of the first cut piece approaches and a position that the cut end 23 of the second cut piece approaches at the cutting of the conductive body 20 (the breakable portion 22).

### <Modification of Communication Passage 57>

The communication passage 57 of the cutting member 50 according to the fourth embodiment may be configured of the hole 58 formed on the main body 51 and a hole through the interior of the blade 52. In this case, the opening at the tip of the communication passage 57 may be formed to be tapered toward the tip surface 52A. In this way, a flow passage area decreases toward the tip of the tapered opening, and the flow rate of gas G increases toward the tip. Thus, gas G is strongly blown to between the cut ends 23 and 24 from the opening, thereby efficiently blowing off the arc.

### <Other Modifications>

Plastic materials may be employed as the materials forming the case 30 and the cutting member 50 according to the first, second and fourth embodiments, but any material having a high strength enough to cut the breakable portion 22 and having a proper electrical insulating property may be employed.

The methods for forming the case 30 and the cutting member 50 according to the first to fourth embodiments may employ any method using molding, cutting or the like.

The conduction breaking device C according to the present invention is not limited to one provided between the storage battery 12 and the converter 14, and any device that is provided between devices in an electric circuit and breaks conduction between the devices may be applied. For example, the present invention may be applied to a conduction breaking device provided between a fuel cell and a vehicle driving motor in a fuel cell vehicle, a conduction breaking device provided between a power supply and an electric device in a stationary system, or a conduction breaking device provided between electric devices in a stationary system.

Therefore, the present examples and embodiments are to be considered as illustrative and not restrictive and the invention is not to be limited to the details given herein, but may be modified within the scope and equivalence of the appended claims.

1. A conduction breaking device comprising:
a conductive body arranged between a pair of devices in an electric circuit;
a gas generator, which is arranged away from the conductive body and generates gas; and
a cutting member, which is arranged between the conductive body and the gas generator, is moved by gas from the gas generator to cut the conductive body, divides the conductive body into a first cut piece and a second cut piece, which have cut ends separated from each other, and breaks the conduction between the devices, wherein
the conduction breaking device includes an arc-extinguishing chamber,
the conductive body is cut by the cutting member in the arc-extinguishing chamber, and
an arc occurring between the cut end of the first cut piece and the cut end of the second cut piece is extinguished in the arc-extinguishing chamber.

2. The conduction breaking device according to claim 1, wherein
the arc-extinguishing chamber is defined by an inner wall made of an electrical insulating material, and
an uneven portion is formed on the inner wall of the arc-extinguishing chamber at an area that at least contains an area between a position that the cut end of the first cut piece approaches and a position that the cut end of the second cut piece approaches at the cutting of the conductive body.

3. The conduction breaking device according to claim 1, wherein
the arc-extinguishing chamber is defined by an inner wall made of an electrical insulating material,
an uneven portion is formed on the inner wall of the arc-extinguishing chamber at an area out of an area between a position that the cut end of the first cut piece approaches and a position that the cut end of the second cut piece approaches at the cutting of the conductive body, and
a magnet for applying a magnetic attractive force to the arc is arranged outside the arc-extinguishing chamber and near the uneven portion.

4. The conduction breaking device according to claim 1, wherein
the conductive body, the gas generator, and the cutting member are arranged inside a case,
the arc-extinguishing chamber is formed in the case on the opposite side of the cutting member across the conductive body, and
in at least one of an inner wall of the arc-extinguishing chamber and the cutting member, an area that at least contains an area between a position that the cut end of the first cut piece approaches and a position that the cut end of the second cut piece approaches at the cutting of the conductive body is made of a material having a thermal conductivity of 0.5 W/(m·K) or more.

5. The conduction breaking device according to claim 1, wherein in at least one of an inner wall of the arc-extinguishing chamber and the cutting member, an area that at least contains an area between a position that the cut end of the first cut piece approaches and a position that the cut end of the second cut piece approaches at the cutting of the conductive body is made of a plastic material that generates ablation gas due to an arc.

6. The conduction breaking device according to claim 1, wherein
an accommodating chamber is provided on the opposite side of the arc-extinguishing chamber across the conductive body,
the cutting member is arranged inside the accommodating chamber, and
the cutting member is formed with a communication passage, and
when the conductive body is cut by the cutting member, the communication passage connects the arc-extinguishing chamber and the accommodating chamber with each other, and ejects gas from the gas generator between the cut end of the first cut piece and the cut end of the second cut piece.

7. The conduction breaking device according to claim 1, wherein
the arc-extinguishing chamber has a polygonal opening opened to face the conductive body,
at least one side of the opening forms a cutting edge portion, and
the cutting member moves to a position near the cutting edge portion inside the arc-extinguishing chamber to cut the conductive body between the cutting member and the cutting edge portion.
